(19) United States
(12) Patent Application Publication
(10) Pub. No.: US 2009/0061341 A1
(43) Pub. Date: Mar. 5, 2009

(54) ELECTROPHOTOGRAPHIC PHOTORECEPTOR HAVING IMPROVED DARK DECAY CHARACTERISTICS AND ELECTROPHOTOGRAPHIC IMAGING APPARATUS EMPLOYING THE SAME

(75) Inventors: Seung-ju KIM, Suwon-si (KR); Moto Makino, Suwon-si (KR); Hwan-koo Lee, Suwon-si (KR); Young-don Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/122,978

(22) Filed: May 19, 2008

(30) Foreign Application Priority Data
Aug. 31, 2007 (KR) 2007-88297

(51) Int. Cl. G03G 15/02; G03G 5/06; G03G 5/07

(52) U.S. Cl. 430/59.4; 430/58.05

(57) ABSTRACT

An electrophotographic photoreceptor including an electrically conductive substrate and a photosensitive layer formed on the electrically conductive substrate, wherein the photosensitive layer includes a charge generating layer and a charge transporting layer, the charge transporting layer containing a predetermined amount of a titanium chelating compound, and an electrophotographic imaging apparatus employing the electrophotographic photoreceptor.

### CROSS-REFERENCE TO RELATED APPLICATIONS

This application claims priority under 35 U.S.C. §119(a) from Korean Patent Application No. 10-2007-0088297, filed on Aug. 31, 2007, in the Korean Intellectual Property Office, the disclosure of which is incorporated herein in its entirety by reference.

### BACKGROUND OF THE INVENTION

1. Field of the Invention

The present general inventive concept relates to an electrophotographic photoreceptor and an electrophotographic imaging apparatus employing the same, and more particularly, to an electrophotographic photoreceptor having improved dark decay characteristics and an electrophotographic imaging apparatus employing the same.

2. Description of the Related Art

Electrophotographic devices, such as facsimile machines, laser printers, copying machines, CRT printers, liquid crystal printers, LED printers, and the like, include an electrophotographic photoreceptor having a photosensitive layer formed on an electrically conductive substrate. The electrophotographic photoreceptor can be in the form of a plate, a disk, a sheet, a belt, a drum, or the like and forms an image as follows. First, a surface of the photosensitive layer is uniformly and electrostatically charged, and then the charged surface is exposed to a pattern of light, thus forming an image. The light exposure selectively dissipates the charge in the exposed regions where the light strikes the surface, thereby forming a pattern of charged and uncharged regions, which is referred to as a latent image. Then, a wet or dry toner is provided in the vicinity of the latent image, and toner droplets or particles collect in either the charged or uncharged regions to form a toner image on the surface of the photosensitive layer. The resulting toner image may be transferred to a suitable final or intermediate receiving surface, such as paper, or the photosensitive layer may function as the final receptor for receiving the image.

Electrophotographic photoreceptors are generally categorized into two types. The first is a laminated-type electrophotographic photoreceptor having a laminated structure including a charge generating layer (CGL) having a binder resin and a charge generating material (CGM), and a charge transporting layer (CTL) having a binder resin and a charge transporting material (usually, a hole transporting material (HTM)). In general, laminated-type electrophotographic photoreceptors constitute negative (−) type electrophotographic photoreceptors. The other type is a single layered-type electrophotographic photoreceptor in which a binder resin, a CGM, an HTM, and an electron transporting material (ETM) are included in a single layer. In general, single layered-type electrophotographic photoreceptors constitute positive (+) type electrophotographic photoreceptors.

Generally, a laminated-type electrophotographic photoreceptor is formed by forming a metal oxide film and/or insulating polymer film on an aluminum drum, and then forming a charge generating layer and a charge transporting layer on the metal oxide film or insulating polymer film. The charge generating layer generates an electric signal by exposure to light, and includes a charge generating material, a binder resin, and optional additives. The charge generating material generates charge carriers, that is, holes and/or electrons, which act as an electric signal when being exposed to light. The charge transporting layer transports the electric signal generated in the charge generating layer to a surface of a photoreceptor drum. The charge transporting layer includes a charge transporting material, a binder resin, and optional additives. The charge transporting material receives at least one type of the charge carriers, and transports the charge carriers via the charge transporting layer in order to easily discharge surface charge.

In a laminated-type electrophotographic photoreceptor, degrading of dark decay characteristics causes image defects, such as background, ghost, and the like. In addition, more image defects may occur when the electrophotographic photoreceptor is repeatedly used for a long period of time.

To address these problems, the following methods have been proposed.

Japanese Laid-open Patent Publication Nos. JP2006-072304, JP2001-40237 and JP hei 7-104496 disclose a method of changing a crystalline type of organic pigments used in a charge generating layer, or a method of using a phthalocyanine-based pigment which contains a metal such as gallium, copper, or the like. However, the method of changing the crystalline type of charge generating materials is complex and requires high costs.

U.S. Pat. Nos. 5,130,218 and 5,804,346 disclose a method of using an organic pigment having a low amount of sulfur as a charge generating material, and a method of adding an organic electron acceptor to a charge generating layer. However, if other compounds are added to the charge generating layer, a dispersion stability of the charge generating material is reduced when a slurry for forming a charge generating layer is prepared.

### SUMMARY OF THE INVENTION

The present general inventive concept provides an electrophotographic photoreceptor which has improved dark decay characteristics.

The present general inventive concept also provides an electrophotographic imaging apparatus employing the electrophotographic photoreceptor.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an electrophotographic photoreceptor including a electrically conductive substrate, and a photosensitive layer formed on the electrically conductive substrate, wherein the photosensitive layer comprises a charge generating layer and a charge transporting layer, wherein the charge transporting layer comprises from 0.05 wt % to less than 0.20 wt % of a titanium chelating compound represented by Formula 1 below based on the weight of the charge transporting layer:

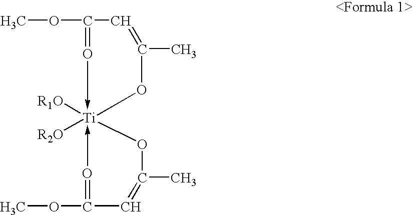

and, wherein R₁ and R₂ are each independently a C₁—C₂₀ linear or branched alkyl group.

The foregoing and/or other aspects and utilities of the present general inventive concept are also achieved by providing an electrophotographic imaging apparatus including an electrophotographic photoreceptor, wherein the electrophotographic photoreceptor comprises an electrically conductive substrate, and a photosensitive layer formed on the electrically conductive substrate, wherein the photosensitive layer comprises a charge generating layer and a charge transporting layer, wherein the charge transporting layer comprises from 0.05 wt % to less than 0.20 wt % of a titanium chelating compound represented by Formula 1 below based on the weight of the charge transporting layer:

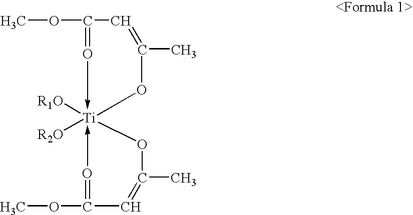

and, wherein R₁ and R₂ are each independently a C₁—C₂₀ linear or branched alkyl group.

R₁ and R₂ may be each independently an isopropyl group or an ethyl group.

The charge generating layer may further include a phthalocyanine-based pigment as a charge generating material.

The electrophotographic photoreceptor may further include an undercoat layer formed between the electrically conductive substrate and the photosensitive layer to prevent charge injection into the photosensitive layer from the electrically conductive substrate.

The foregoing and/or other aspects and utilities of the present general inventive concept are also achieved by providing an electrophotographic photoreceptor, including an electrically conductive substrate, a charge generating layer formed on the electrically conductive substrate; and a charge transportation layer formed on the charge generating layer, the charge transportation layer comprising a titanium chelating compound.

The titanium chelating compound may be less than 0.20% by weight based on a total weight of the charge transporting layer.

The charge generating layer may include an organic pigment and a binder resin.

The foregoing and/or other aspects and utilities of the present general inventive concept are also achieved by providing a method of improving dark decay characteristics of an electrophotographic photoreceptor, the method including adding an effective amount of a titanium chelating compound to a charge transportation layer formed on the electrophotographic photoreceptor.

The effective amount of the titanium chelating compound may be less than 0.20% by weight based on a total weight of the charge transporting layer.

An effective amount of titanium chelating compound may improve the dark decay characteristics of the electrophotographic photoreceptor while not substantially reducing a sensitivity of the electrophotographic photoreceptor.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating an electrophotographic imaging apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The electrophotographic receptor according to an embodiment of the present general inventive concept has a laminated structure in which a charge generating layer and a charge transporting layer may be sequentially formed on an electrically conductive substrate, wherein the charge generating layer and the charge transporting layer together constitute a photosensitive layer. However, the present general inventive concept is not limited thereto, and the formation sequence of the charge transporting layer and the charge generating layer can be reversed.

The electrically conductive substrate may be in the form of a drum, pipe, belt, plate or the like which may include any conductive material, for example, a metal, or an electrically conductive polymer, or the like. The metal may be aluminium, vanadium, nickel, copper, zinc, palladium, indium, tin, platinum, stainless steel, chrome, or the like. The electrically conductive polymer may be a polyester resin, polycarbonate resin, a polyamide resin, a polyimide resin, mixtures thereof, or a copolymer of monomers used in preparing the resins described above in which an electrically conductive material, such as a conductive carbon, tin oxide, indium oxide, or the like, is dispersed. An organic polymer sheet on which a metal is deposited or a metal sheet is laminated may be used as the electrically conductive substrate.

An undercoat layer may be further formed between the electrically conductive substrate and the photosensitive layer in order to prevent charge injection to the photosensitive layer from the electrically conductive substrate and/or improve adhesion therebetween.

The undercoat layer may be formed by dispersing a conductive powder, such as carbon black, graphite, metal powder, or a metal oxide powder, such as indium oxide, tin oxide, indium tin oxide, or titanium oxide, in a binder resin, such as polyamide, polyvinylalcohol, casein, ethylcellulose, gelatin, a phenol resin, or the like. The undercoat layer in this form may have a thickness of about 5 μm to about 50 μm. The undercoat layer may also be an anodized layer of Al. A thickness of the anodized layer of Al may be in the range of from about 0.05 μm to about 5 μm. The undercoat layer may include both a layer formed by dispersing a conductive power in a binder resin and an anodized layer of Al.

The photosensitive layer, including the charge generating layer and the charge transporting layer, is formed on the electrically conductive substrate of the laminated electrophotographic photoreceptor according to an embodiment of the present general inventive concept.

A charge generating material used to form the charge generating layer may be an organic pigment or an inorganic pigment. If an organic pigment is used as the charge generating material, electrical properties of the electrophotographic photoreceptor can easily be adjusted and various crystalline structures can be obtained depending on synthesis methods and processing conditions. Thus, the use of an organic pigment may be preferable. Examples of the charge generating material may include a phthalocyanine-based pigment, an azo-based compound, a bisazo-based compound, a triazo-based compound, a quinone-based pigment, a perylene-based compound, an indigo-based compound, a bisbenzoimidazole-based pigment, an anthraquinone-based compound, a quinacridone-based compound, an azulenium-based compound, a squarylium-based compound, a pyrylium-based compound, a triarylmethane-based compound, a cyanine-based compound, a perynone-based compound, a polycycloquinone-based compound, a pyrrolopyrrole-based compound, a naphthalocyanine-based compound, and the like, but the present general inventive concept is not limited thereto. The charge generating materials can be used alone or in combination of two or more. The charge generating material may be preferably a phthalocyanine-based pigment. Examples of the phthalocyanine-based pigment may include a titanyloxy phthalocyanine pigment, such as D-type or Y-type titanyloxy phthalocyanine having a strongest diffraction peak at a Bragg angle of about 27.1°(2θ±0.2°), a β-type titanyloxy phthalocyanine having a strongest diffraction peak at a Bragg angle of about 26.1°(2θ±0.2°), an α-type titanyloxy phthalocyanine having a strongest diffraction peak at a Bragg angle of about 7.5°(2θ±0.2°), or the like, in a powder X-ray diffraction peak; or a metal-free phthalocyanine pigment, such as X-type metal-free phthalocyanine or τ-type metal-free phthalocyanine having a strongest diffraction peak at Bragg angles of about 7.5° and about 9.2°(2θ±0.2°) in a powder X-ray diffraction peak. Phthalocyanine-based pigments have the highest sensitivity to light at a wavelength in the range of 780-800 nm and a sensitivity being adjustable to some extent dependent on a crystalline structure of the pigments, and thus can be effectively used in the present general inventive concept.

The charge generating material used in the charge generating layer can be dispersed in a binder resin. The binder resin may include polyvinylbutyral, polyvinylacetal, polyester, polyamide, polyvinylalcohol, polyvinylacetate, polyvinylchloride, polyurethane, polycarbonate, polymethylmethacrylate, polyvinylidenechloride, polystyrene, styrene-butadiene copolymer, styrene-methyl methacrylate copolymer, vinylidenechloride-acrylonitrile copolymer, vinylchloride-vinylacetate copolymer, vinylchloride-vinylacetate-maleic anhydride copolymer, ethylene-acrylic acid copolymer, ethylene-vinylacetate copolymer, methylcellulose, ethylcellulose, nitrocellulose, carboxymethyl cellulose, polysilicone, a silicone-alkid resin, a phenol-formaldehyde resin, a cresol-formaldehyde resin, a phenoxy resin, a styrene-alkid resin, a poly-N-vinylcarbazole resin, polyvinylformal, polyhydroxystyrene, polynorbornene, polycycloolefines, polyvinylpyrroidone, poly(2-ethyl-oxazoline), polysulfone, a melamin resin, an urea resin, an amino resin, an isocyanate resin, an epoxy resin, or the like, but the present general inventive concept is not limited thereto. The binder resin can be used alone or in combination of two or more.

An amount of the binder resin may be in a range of from about 5 to about 350 parts by weight, and preferably in a range of from about 10 to about 200 parts by weight, based on 100 parts by weight of the charge generating material. If an amount of the binder resin is less than 5 parts by weight based on 100 parts by weight of the charge generating material, the charge generating material is not fully dispersed, and thus, the obtained dispersion solution is less stable, and when the dispersion solution is coated on the electrically conductive substrate, a uniform charge generating layer cannot be obtained, and also, an adhesive force between the charge generating layer and the electrically conductive substrate can be reduced. If the amount of the binder resin is greater than 350 parts by weight based on 100 parts by weight of the charge generating material, a charging potential cannot be maintained and the photosensitivity of the charge generating layer is low due to an excessive amount of the binder resin, and thus a desired image cannot be obtained.

A solvent used in preparing a coating composition to form a charge generating layer can vary according to the type of the binder resin used, and preferably, should not have an adverse effect on an adjacent layer when forming the charge generating layer. Examples of the solvent may include methyl isopropyl ketone, methyl isobutyl ketone, 4-methoxy-4-methyl-2-pentanone, isopropyl acetate, t-butyl acetate, isopropyl alcohol, isobutyl alcohol, acetone, methylethyl ketone, cyclohexanone, 1,2-dichloroethane, 1,1,2-trichloroethane, 1,1,1-trichloroethane, trichloroethylene, tetrachloroethane, dichloromethane, tetrahydrofuran, dioxane, dioxolane, methanol, ethanol, 1-propanol, 1-butanol, 2-butanol, 1-methoxy-2-propanol, ethyl acetate, butyl acetate, dimethyl sulfoxide, methylcellosolve, butyl amine, diethyl amine, ethylene diamine, isopropanol amine, triethanol amine, triethylene diamine, N,N′-dimethyl formamide, 1,2-dimethoxyethane, benzene, toluene, xylene, methylbenzene, ethylbenzene, cyclohexane, anisole, and the like. These solvents may be used alone or in combination of two or more.

Next, a method of preparing a coating composition to form the charge generating layer according to an embodiment of the present general inventive concept will be described. First, 100 parts by weight of a charge generating material, such as a phthalocyanine pigment, and 5 to 350 parts by weight, more preferably 10 to 200 parts by weight, of a binder resin are mixed with an appropriate amount of a solvent, for example, 100 to 10,000 parts by weight, preferably 500 to 8,000 parts by weight. Glass beads, steel beads, zirconia beads, alumina beads, zirconia balls, alumina balls, or steel balls are added to the mixture and the resulting mixture is dispersed using a dispersing apparatus for about 2 to 50 hours. The dispersing apparatus used herein may be, for example, an attritor, a ball-mill, a sand-mill, a banburry mixer, a roll-mill, three-roll mill, nanomiser, microfluidizer, a stamp mill, a planetary mill, a vibration mill, a kneader, a homonizer, a Dyno-Mill, a micronizer, a paint shaker, a high-speed agitator, an ultimiser, an ultrasonic homogenizer, or the like. The above dispersing apparatuses may be used alone or in combination of two or more.

The coating slurry to form the charge generating layer is coated on the above-described electrically conductive substrate using a coating method, such as a dip coating method, a ring coating method, a roll coating method, a spray coating method, or the like. The coated electrically conductive substrate is dried at 90 to 200° C. for 0.1 to 2 hours, thereby forming the charge generating layer.

A thickness of the charge generating layer may be 0.001 to 10 μm, preferably 0.01 to 10 μm, and more preferably 0.05 to 3 μm. When the thickness of the charge generating layer is less than 0.001 μm, it is difficult to form the charge generating layer to have a uniform thickness. When the thickness of the charge generating layer is greater than 10 μm, electrophotographic characteristics tend to be degraded.

Subsequently, the charge transporting layer including a charge transporting material, a titanium chelating compound, and a binder resin is formed on the charge generating layer.

The charge transporting materials can be categorized into a hole transporting material and an electron transporting material. When a laminated-type photoreceptor is employed as a negative (−) charge type photoreceptor, a hole transporting material is used as the charge transporting material. When both positive (+) and negative (−) charge properties are required, a hole transporting material and an electron transporting material can be simultaneously used. Examples of the hole transporting material that may be used herein include nitrogen containing cyclic compounds or condensed polycyclic compounds, such as a hydrazone-based compound, a butadiene-based amine compound, benzidine-based compounds including N,N′-bis-(3-methylphenyl)-N,N′-bis(phenyl)benzidine, N,N, N′,N′-tetrakis(3-methylphenyl)benzidine, N,N, N′,N′-tetrakis(4-methylphenyl)benzidine, N,N′-di(naphthalene-1-yl)-N,N′-di(4-methylphenyl)benzidine, and N,N′-di(naphthalene-2-yl)-N,N′-di(3-methylphenyl)benzidine, a pyrene-based compound, a carbazole-based compound, an arylmethane-based compound, a thiazol-based compound, a styryl-based compound, a pyrazoline-based compound, an arylamine-based compound, an oxazole-based compound, an oxadiazole-based compound, a pyrazolone-based compound, a stilbene-based compound, a polyaryl alkane-based compound, a polyvinylcarbazole-based compound, a N-acrylamide methylcarbazole copolymer, a triphenylmethane copolymer, a styrene copolymer, polyacenaphthene, polyindene, a copolymer of acenaphthylene and styrene, and a formaldehyde-based condensed resin. Also, a high molecular weight compound having substituents of the above compounds in a backbone or a side chain may be used.

When the charge transporting layer includes an electron transporting material, the electron transporting material that may be used is not limited and may be any known electron transporting material. Specifically, examples of the electron transporting material may include an electron attracting low-molecular weight compound, for example, a benzoquinone-based compound, a naphthoquinone-based compound, an anthraquinone-based compound, a malononitrile-based compound, a fluorenone-based compound, a cyanoethylene-based compound, a cyanoquinodimethane-based compound, a xanthone-based compound, a phenanthraquinone-based compound, a phthalic anhydride-based compound, a dicyanofluorenone-based compound, a naphthalenetetracarboxylic acid diimide compound, a benzoquinonimine-based compound, a diphenoquinone-based compound, a stilbene quinone-based compound, a diiminoquinone-based compound, a dioxotetracenedione compound, and a thiopyrane-based compound, or the like.

However, the charge transporting material that may be used in the present general inventive concept is not limited to the above-described hole transporting material and electron transporting material. A material having a charge mobility greater than 10⁻⁸ cm²/V ▪ sec can be used. The charge transporting materials may be used alone or in combination of two or more.

When the charge transporting material itself has a film forming property, a charge transporting layer can be formed without using a binder resin. In general, a low molecular material cannot form a thin film by itself. Accordingly, a composition to form a charge transporting layer having a charge transporting material and a binder resin dissolved or dispersed in a solvent is formed, and the composition is coated on the charge generating layer and dried, thereby forming a charge transporting layer. Examples of the binder resin used in the formation of the charge transport layer include, but are not limited to, an insulation resin which can form a film, such as polyvinyl butyral, polyarylates (condensed polymer of bisphenol A and phthalic acid, and so on), polycarbonate, a polyester resin, a phenoxy resin, polyvinyl acetate, acrylic resin, a polyacrylamide resin, a polyamide, polyvinyl pyridine, a cellulose-based resin, a urethane resin, an epoxy resin, a silicone resin, polystyrene, a polyketone, polyvinyl chloride, vinyl chloride-vinyliacetate copolymer, polyvinyl acetal, polyacrylonitrile, a phenolic resin, a melamine resin, casein, polyvinyl alcohol, and polyvinyl pyrrolidone; and an organic photoconducting polymer, such as poly N-vinyl carbazole, polyvinyl anthracene, polyvinyl pyrene, and so on.

However, the present inventors have found that a polycarbonate resin may be a preferable binder resin to be used to form a charge transporting layer. In particular, polycarbonate-Z derived from cyclohexylidene bisphenol is preferable to polycarbonate-A derived from bisphenol A or polycarbonate-C derived from methylbisphenol-A, because polycarbonate-Z has a high glass transition temperature and high abrasion resistance. The amount of the binder resin used may be preferably about 5 to 200 parts by weight, and more preferably about 10 to 150 parts by weight of the charge transporting material based on 100 parts by weight of the binder resin.

The titanium chelating compound contained in the charge transporting layer may be represented by Formula 1 below.

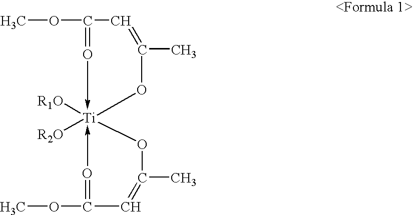

wherein R₁ and R₂ may each independently be a C₁—C₂₀ linear or branched alkyl group, preferably each independently a C₁—C₁₀ linear or branched alkyl group, and more preferably a C₁—C₅ linear or branched alkyl group. Examples of R₁ and R₂ may include, but are not limited to, a methyl group, an ethyl group, a propyl group, an isopropyl group, a butyl group, and an isobutyl group. Preferably, R₁ and R₂ may be each independently an isopropyl group or an ethyl group.

Examples of the titanium chelating compound that are commercially-available may include Tyzor® from Dupont and VERTEC IA10, VERTEC KE2, VERTEC KE4, and VERTEC KE6 which are brand names and are manufactured by Johnson Matthey Catalysts.

The amount of the titanium chelating compound represented by Formula 1 may be from 0.05 wt % to less than 0.20 wt %, preferably from 0.05 to 0.15 wt % based on the total weight of the charge transporting layer. When the amount of the titanium chelating compound is less than 0.05 wt % with respect to the total weight of the charge transporting layer, dark decay improvement, and accordingly, obtained image quality improvement can be insufficient. On the other hand, when the amount of the titanium chelating compound is equal to or more than 0.02 wt % with respect to the total weight of the charge transporting layer, sensitivity of the photoreceptor can be reduced.

The charge transporting layer may include a phosphate-based compound, a phosphine oxide-based compound, a silicone oil, or the like, in order to enhance the abrasion resistance and increase a slippage of the surface of the charge transporting layer.

The solvent used to prepare the coating composition to form the charge transporting layer of the electrophotographic photoreceptor may be varied according to the type of the binder resin, and may preferably be selected in such a way that it does not affect the charge generating layer formed underneath. Specifically, the solvent may be, for example, aromatic hydrocarbons, such as benzene, xylene, ligroin, monochlorobenzene, and dichlorobenzene; ketones, such as acetone, methyl ethyl ketone, and cyclohexanone; alcohols, such as methanol, ethanol, and isopropanol; esters, such as ethyl acetate and methyl cellosolve; halogenated aliphatic hydrocarbons, such as carbon tetrachloride, chloroform, dichloromethane, dichloroethane, and trichloroethylene; ethers, such as tetrahydrofuran, dioxane, dioxolan, ethylene glycol, and monomethyl ether; amides, such as N,N-dimethyl formamide, N,N-dimethyl acetamide; and sulfoxides, such as dimethyl sulfoxide. These solvents may be used alone or in combination of two or more.

Next, a method of preparing the coating composition to form the charge transporting layer according to an embodiment of the present general inventive concept will be described.

First, 100 parts by weight of a binder resin, 5 to 200 parts by weight of a charge transporting material, and from 0.05 wt % to less than 0.20 wt % of the titanium chelating compound represented by Formula 1 based on the total weight of the binder resin and the charge transporting material are mixed with an appropriate amount of a solvent, for example, 100 to 1,500 parts by weight, preferably 300 to 1,200 parts by weigh and the mixture is stirred. The prepared coating solution to form the charge transporting layer is coated on the charge generating layer using, as described above, a dip coating method, a ring coating method, a roll coating method, a spray coating method, or the like. The conductive substrate on which the charge transporting layer is coated is dried at 90 to 200° C. for 0.1 to 2 hours, thereby forming the charge transporting layer.

The thickness of the charge transporting layer may be 2 to 100 μm, preferably 5 to 50 μm, and more preferably 10 to 40 μm. When the thickness of the charge transporting layer is less than 2 μm, the charge transporting layer is too thin, and thus it is not sufficiently durable. When the thickness of the charge transporting layer is greater than 100 μm, a physical abrasion resistance tends to increase but the printing image quality tends to be degraded.

The electrophotographic photoreceptor of the present general inventive concept may further include additives, such as an antioxidant, an optical stabilizer, a plasticizer, a leveling agent, and a dispersion stabilizing agent, in at least one of the charge transporting layer and the charge generating layer in order to increase a stability of the electrophotographic photoreceptor with respect to environmental conditions or harmful light. Examples of the antioxidant may include any known antioxidant, for example, hindered phenol-based compounds, sulfur-based compounds, esters of phosphonic acid, esters of hypophosphoric acid, and amine-based compounds, but are not limited thereto. Examples of the optical stabilizer may include any know optical stabilizer, for example, benzotriazole-based compounds, benzophenone-based compounds, and hindered amine-based compounds, but are not limited thereto. The electrophotographic photoreceptor of the present general inventive concept may further include a surface protecting layer, if necessary.

The electrophotographic photoreceptor of the present general inventive concept may be incorporated into electrophotographic imaging apparatuses, such as laser printers, copying machines, facsimile machines, LED printers, and the like.

Hereinafter, an electrophotographic imaging apparatus using the electrophotographic photoreceptor according to an embodiment of the present general inventive concept will be described.

The electrophotographic imaging apparatus according to the present general inventive concept includes an electrophotographic photoreceptor, wherein the electrophotographic photoreceptor has a laminated structure which includes an electrically conductive substrate and a charge generating layer and charge transporting layer which are formed on the electrically conductive substrate, wherein the charge transporting layer comprises from 0.05 wt % to less than 0.20 wt % of a titanium chelating compound represented by Formula 1 above based on the weight of the charge transporting layer.

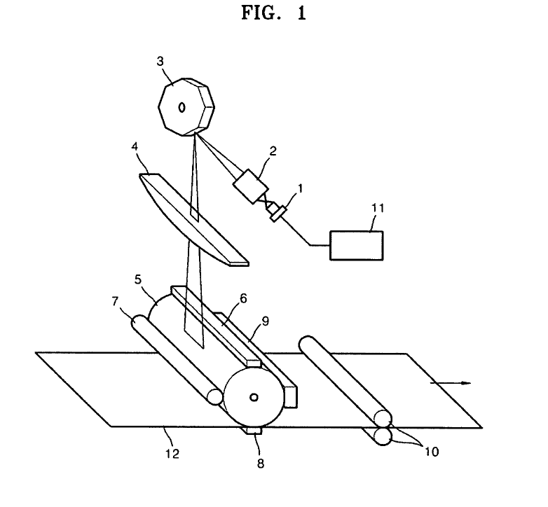

FIG. 1 schematically illustrates an electrophotographic image forming apparatus according to an embodiment of the present general inventive concept. Referring to FIG. 1, the electrophotographic imaging apparatus may include a semiconductor laser 1. Laser light that is signal-modulated by a control circuit 11 according to image information is collimated by an optical correction system 2 after being radiated and performs scanning while being reflected by a polygonal rotatory mirror 3. The laser light is focused on a surface of an electrophotographic photoreceptor 5 by a f-θ lens 4 and exposes the surface according to the image information. Since the electrophotographic photoreceptor may be already charged by a charging apparatus 6, an electrostatic latent image is formed by the exposure, and then becomes visible by a developing apparatus 7. The visible image is transferred to an image receptor 12, such as paper, by a transferring apparatus 8, and is fixed in a fixing apparatus 10 and provided as a print result. The electrophotographic photoreceptor can be used repeatedly by removing coloring agent that remains on the surface thereof by a cleaning apparatus 9. The electrophotographic photoreceptor here is illustrated in the form of a drum, however, as described above, the present general inventive concept is not limited thereto, and it may also be in the form of a sheet, a belt, or the like.

Hereinafter, the present general inventive concept will be described in further detail with reference to the following examples. These examples are for illustrative purposes only and are not intended to limit the scope of the present general inventive concept.

### EXAMPLE

### Example 1

20 parts by weight of y-TiOPc (titanyloxy phthalocyanine) represented by Formula 10 below as a charge generating material, 13 parts by weight of polyvinylbutyral (Sekisui Chemical Co. Ltd., “LEC BM-1”) represented by Formula 20 below as a binder resin, and 635 parts by weight of tetrahydrofuran (THF) were mixed, and then the mixture was sand milled for 2 hours and further dispersed using ultrasonic waves. The obtained composition to form a charge generating layer was dip coated on an anodized aluminum drum having a diameter of 30 mm and dried at 120° C. for about 20 minutes to form a charge generating layer (CGL).

30 parts by weight of a hydrazone-based compound represented by Formula 30 below as a hole transporting material (HTM), 50 parts by weight of a polycarbonate Z resin (Mitsubishi Gas Chemical, PCZ200,) represented by Formula 40 below as a binder resin, and 0.04 parts by weight (the weight of isopropyl alcohol as a solvent was excluded) of a titanium chelating compound (Tyzor AA, DuPont) represented by Formula 50 below where R1 and R2 are each independently an isopropyl group, and the content of TiO₂ is 16.5%) were dissolved in 426 parts by weight of THF/toluene cosolvent (weight ratio=4/1) to obtain a composition, which was used to form a charge transporting layer. The weight of the titanium chelating compound was an amount corresponding to 0.05 wt % based on the total weight of the HTM and the binder resin. The obtained composition was dip coated on the charge generating layer formed on the anodized aluminum drum and dried at 120° C. for about 30 minutes to form a charge transporting layer. As a result, a laminated electrophotographic photoreceptor drum was manufactured. The thickness of the obtained photosensitive layer was about 12 μm.

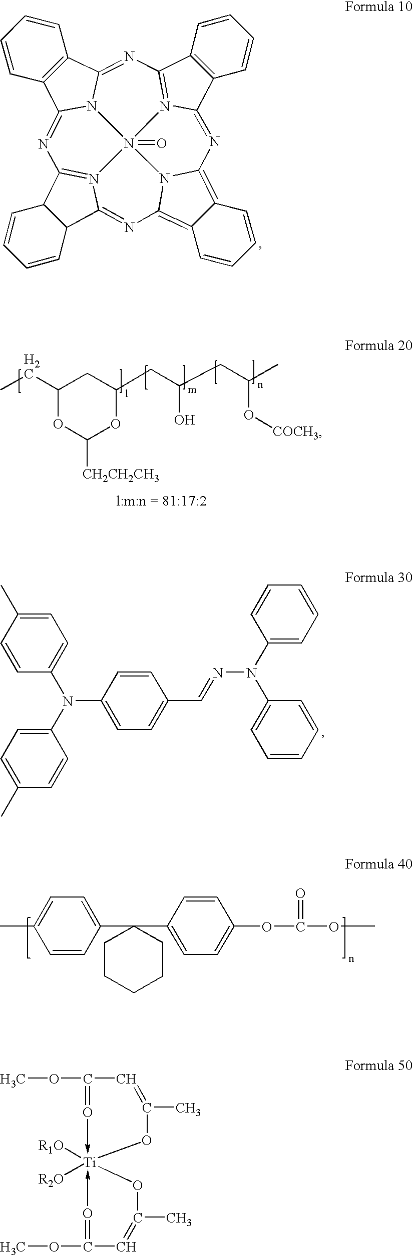

### Example 2

A laminated-type electrophotographic photoreceptor drum was prepared in the same manner as in Example 1, except that 0.08 parts by weight (the weight of isopropyl alcohol as a solvent was excluded) of Tyzor AA was used as the titanium chelating compound. The weight of the titanium chelating compound was an amount corresponding to 0.1 wt % based on the total weight of the HTM and the binder resin.

### Example 3

A laminated-type electrophotographic photoreceptor drum was prepared in the same manner as in Example 1, except that 0.12 parts by weight (the weight of isopropyl alcohol as a solvent was excluded) of Tyzor AA was used as the titanium chelating compound. The weight of the titanium chelating compound was an amount corresponding to 0.15 wt % based on the total weight of the HTM and the binder resin.

### Example 4

A laminated-type electrophotographic photoreceptor drum was prepared in the same manner as in Example 1, except that 0.04 parts by weight of Tyzor AA-65 (R1=a isopropyl group, R2=an ethyl group, TiO₂ content 15.0%) was used as the titanium chelating compound. The weight of the titanium chelating compound was an amount corresponding to 0.05 wt % based on the total weight of the HTM and the binder resin.

### Example 5

A laminated-type electrophotographic photoreceptor drum was prepared in the same manner as in Example 1, except that 0.08 parts by weight (the weight of isopropyl alcohol as a solvent was excluded) of Tyzor AA-65 was used as the titanium chelating compound. The weight of the titanium chelating compound was an amount corresponding to 0.1 wt % based on the total weight of the HTM and the binder resin.

### Example 6

A laminated-type electrophotographic photoreceptor drum was prepared in the same manner as in Example 1, except that 0.12 parts by weight (the weight of isopropyl alcohol as a solvent was excluded) of Tyzor AA-65 was used as the titanium chelating compound. The weight of the titanium chelating compound was an amount corresponding to 0.15 wt % based on the total weight of the HTM and the binder resin.

### Example 7

A laminated-type electrophotographic photoreceptor drum was prepared in the same manner as in Example 1, except that 0.04 parts by weight of Tyzor AA-105 (R1=a isopropyl group, R2=an ethyl group, TiO₂ content 23.0%) was used as the titanium chelating compound. The weight of the titanium chelating compound was an amount corresponding to 0.05 wt % based on the total weight of the HTM and the binder resin.

### Example 8

A laminated-type electrophotographic photoreceptor drum was prepared in the same manner as in Example 1, except that 0.08 parts by weight of Tyzor AA-105 was used as the titanium chelating compound. The weight of the titanium chelating compound was an amount corresponding to 0.1 wt % based on the total weight of the HTM and the binder resin.

### Example 9

A laminated-type electrophotographic photoreceptor drum was prepared in the same manner as in Example 1, except that 0.12 parts by weight of Tyzor AA-105 was used as the titanium chelating compound. The weight of the titanium chelating compound was an amount corresponding to 0.15 wt % based on the total weight of the HTM and the binder resin.

### Comparative Example 1

A laminated-type electrophotographic photoreceptor drum was prepared in the same manner as in Example 1, except that the titanium chelating compound was not used.

### Comparative Example 2

A laminated-type electrophotographic photoreceptor drum was prepared in the same manner as in Example 1, except that 0.16 parts by weight (the weight of isopropyl alcohol as a solvent was excluded) of Tyzor AA was used as the titanium chelating compound. The weight of the titanium chelating compound was an amount corresponding to 0.20 wt % based on the total weight of the HTM and the binder resin.

### Comparative Example 3

A laminated-type electrophotographic photoreceptor drum was prepared in the same manner as in Example 1, except that 0.16 parts by weight (the weight of isopropylalcohol as a solvent was excluded) of Tyzor AA-65 was used as the titanium chelating compound. The weight of the titanium chelating compound was an amount corresponding to 0.20 wt % based on the total weight of the HTM and the binder resin.

### Comparative Example 4

A laminated-type electrophotographic photoreceptor drum was prepared in the same manner as in Example 1, except that 0.16 parts by weight of Tyzor AA-105 was used as the titanium chelating compound. The weight of the titanium chelating compound was an amount corresponding to 0.20 wt % based on the total weight of the HTM and the binder resin.

### Evaluation of Electrophotographic Properties

The electrophotographic property of each of the laminated-type electrophotographic photoreceptor drums manufactured in Examples 1 through 9 and Comparative Examples 1 through 4 was measured using an apparatus to estimate a drum type photoreceptor (“PDT-2000”, available from QEA Co.) at 23° C. and a relative humidity of 50% as follows.

Each of the electrophotographic photoreceptor drums was at a corona voltage of −7.5 kV and at a relative speed of 100 mm/sec of the charging unit and the photoreceptor so that the initial surface potential Vo (V) of the photoreceptors could be −800V. Right after that, the surface potential of each of the electrophotographic photoreceptor drums was measured when the electrophotographic photoreceptor drums were exposed to light by irradiating a monochromatic light having a wavelength of 780 nm. Then, the relationship of exposure energy versus surface potential of each of the electrophotographic photoreceptor drums was measured. From this, E½ (μJ/cm2) (sensitivity) which denotes exposure energy per unit area that is required in order for the surface potential of the electrophotographic photoreceptor drums to become half of the initial potential thereof, residual voltage Vr (V), DD₁(%) which denotes dark decay rate 1 second after the electrophotographic photoreceptor drums were charged, and DD₅(%) which denotes dark decay rate 5 seconds after the electrophotographic photoreceptor drums were charged were obtained.

DD₁(%) and DD5(%) were calculated as follows.

DD₁(%)=(Vo−V1)×100/Vo

DD₅(%)=(Vo−V5)×100/Vo

Vo denotes an initial surface potential in the dark, V1 denotes a surface potential in the dark after 1 second is elapsed after the charging, and V5 denotes a surface potential in the dark after 5 seconds is elapsed after the charging.

In addition, to evaluate the charge potential stability, a voltage of −7.2 kV was applied to each of the electrophotographic photoreceptor drums using a corona charging unit, and initial charge voltage Voᵢₙᵢₜᵢₐₗ(V) of the electrophotographic photoreceptor drums and charge voltage Vo_{1,000}(V) of the electrophotographic photoreceptor drums after the cycle of charging and exposure to light were consecutively performed 1,000 times were measured.

### Evaluation of Image Quality

The image quality of each of the electrophotographic photoreceptor drums prepared in Examples 1 through 9 and Comparative Examples 1 through 4 was evaluated by installing the electrophotographic photoreceptor drums in a commercially available laser printer (Product: ML-3560, available from Samsung Electronics Co., Ltd) under the conditions of 23° C./50% relative humidity as follows.

A black solid pattern of a regular square having sides of 10 mm was printed on a sheet of A4 white paper.

### Background (BG) Measurement

The background (BG) of the A4 white paper was observed with the naked eye to be evaluated as follows.
No occurrence: hardly observed
Occurrence: at least slightly observed

### Ghost Measurement

Printing was performed using an A4 paper in which the test image pattern of the letter “A” having a height of 20 mm was printed on a top portion of the paper. Then, it was determined whether the image pattern placed on a top portion of the paper was printed on a lower portion of the printed A4 paper (the lower portion corresponds to a portion that is separated from the top portion a distance greater than one rotation length of the photoreceptor drum) to evaluate a ghost phenomenon. The determination standard of the ghost phenomenon was as follows.
No occurrence: hardly observed
Occurrence: at least slightly observed

Table 1 below represents the results of evaluating electrophotographic properties and image qualities of the electrophotographic photoreceptor drums.

TABLE 1

| | E½ | Vr | DD₁ | DD₅ | Voᵢₙᵢₜᵢₐₗ | Vo_{1,000} | | |
|---|---|---|---|---|---|---|---|---|
| | (μJ/cm2) | (V) | (%) | (%) | (V) | (V) | BG | Ghost |
| Comparative | 0.212 | 2.260 | 97.5 | 88.5 | 762 | 620 | Occurrence | Occurrence |
| Example 1 | | | | | | | | |
| Example 1 | 0.218 | 2.263 | 99.0 | 95.0 | 770 | 760 | No | No |
| | | | | | | | occurrence | occurrence |
| Example 2 | 0.228 | 2.260 | 99.2 | 96.2 | 772 | 774 | No | No |
| | | | | | | | occurrence | occurrence |
| Example 3 | 0.254 | 2.255 | 99.6 | 97.0 | 774 | 770 | No | No |
| | | | | | | | occurrence | occurrence |
| Comparative | 0.284 | 5.630 | 99.5 | 97.8 | 770 | 785 | No | No |
| Example 2 | | | | | | | occurrence | occurrence |
| Example 4 | 0.224 | 2.250 | 99.3 | 94.7 | 768 | 760 | No | No |
| | | | | | | | occurrence | occurrence |
| Example 5 | 0.232 | 2.325 | 99.4 | 96.0 | 780 | 772 | No | No |
| | | | | | | | occurrence | occurrence |
| Example 6 | 0.255 | 2.270 | 99.7 | 97.8 | 782 | 784 | No | No |
| | | | | | | | occurrence | occurrence |
| Comparative | 0.289 | 5.880 | 99.7 | 98.0 | 775 | 794 | No | No |
| Example 3 | | | | | | | occurrence | occurrence |
| Example 7 | 0.230 | 2.224 | 99.1 | 94.2 | 773 | 776 | No | No |
| | | | | | | | occurrence | occurrence |
| Example 8 | 0.241 | 2.160 | 99.4 | 97.0 | 778 | 770 | No | No |
| | | | | | | | occurrence | occurrence |
| Example 9 | 0.254 | 1.970 | 99.7 | 98.1 | 788 | 772 | No | No |
| | | | | | | | occurrence | occurrence |
| Comparative | 0.302 | 6.021 | 99.7 | 98.5 | 775 | 795 | No | No |
| Example 4 | | | | | | | occurrence | occurrence |

As can be seen in Table 1, in the case of Comparative Example 1 which did not use the titanium chelating compound to form the charge transporting layer, DD₁(%) and DD₅(%) were low, the charge potential stability was poor, and image defects, such as background and ghost phenomena occurred. By contrast, in the case of Examples 1 through 9 which used an appropriate amount of the titanium chelating compound to form the charge transporting layer, DD₁(%) and DD₅(%) were significantly increased, the charge potential stability was excellent, and the image defects, such as background and ghost phenomena did not occur.

On the other hand, in the case of Comparative Example 2 through 4 which used an excessive amount of the titanium chelating compound to form the charge transporting layer, the dark decay rates were increased, the charge potential stability was excellent, and the image defects, such as background and ghost phenomena did not occur; however, the sensitivity (E½) was reduced.

The charge transporting layer of the electrophotographic photoreceptor according to the present general inventive concept includes from 0.05 wt % to less than 0.20 wt % of the titanium chelating compound represented by Formula 1 based on the weight of the charge transporting layer, thereby having excellent electrophotographic properties of dark decay rates, charge potential stability and sensitivity. Therefore, when images are formed using the electrophotographic photoreceptor of the present general inventive concept, high-quality images in which image defects, such as background and ghost phenomena do not occur can be stably obtained.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. An electrophotographic photoreceptor, comprising:
an electrically conductive substrate; and
a photosensitive layer formed on the electrically conductive substrate,
wherein the photosensitive layer comprises a charge generating layer and a charge transporting layer,
wherein the charge transporting layer comprises from 0.05 wt % to less than 0.20 wt % of a titanium chelating compound represented by Formula 1 below based on the weight of the charge transporting layer: 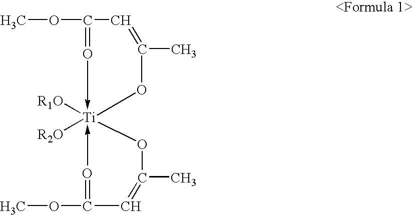
and, wherein R₁ and R₂ are each independently a C₁—C₂₀ linear or branched alkyl group.

2. The electrophotographic photoreceptor of claim 1, wherein R₁ and R₂ are each independently an isopropyl group or an ethyl group.

3. The electrophotographic photoreceptor of claim 1, wherein the charge generating layer further comprises a phthalocyanine-based pigment as a charge generating material.

4. The electrophotographic photoreceptor of claim 1, further comprising:
an undercoat layer formed between the electrically conductive substrate and the photosensitive layer to prevent charge injection into the photosensitive layer from the electrically conductive substrate.

5. An electrophotographic imaging apparatus, comprising:
an electrophotographic photoreceptor, wherein the electrophotographic photoreceptor comprises an electrically conductive substrate; and
a photosensitive layer formed on the electrically conductive substrate, wherein the photosensitive layer comprises a charge generating layer and a charge transporting layer, wherein the charge transporting layer comprises from 0.05 wt % to less than 0.20 wt % of a titanium chelating compound represented by Formula 1 below based on the weight of the charge transporting layer: 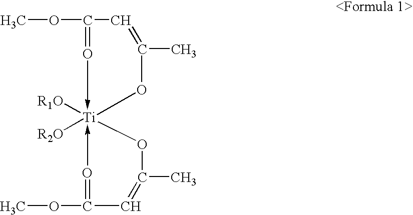
and, wherein R₁ and R₂ are each independently a C₁—C₂₀ linear or branched alkyl group.

6. The electrophotographic imaging apparatus of claim 5, wherein R₁ and R₂ are each independently an isopropyl group or an ethyl group.

7. The electrophotographic imaging apparatus of claim 5, wherein the charge generating layer comprises a phthalocyanine-based pigment as a charge generating material.

8. The electrophotographic imaging apparatus of claim 5, further comprising an undercoat layer formed between the electrically conductive substrate and the photosensitive layer to prevent charge injection into the photosensitive layer from the electrically conductive substrate.

9. An electrophotographic photoreceptor, comprising:
an electrically conductive substrate;
a charge generating layer formed on the electrically conductive substrate; and
a charge transportation layer formed on the charge generating layer, the charge transportation layer comprising a titanium chelating compound represented by Formula 1 below: 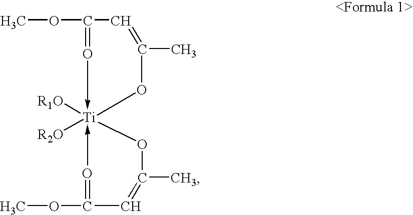
wherein R₁ and R₂ are each independently a C₁—C₂₀ linear or branched alkyl group.

10. The electrophotographic photoreceptor of claim 9, wherein the titanium chelating compound is less than 0.20% by weight based on a total weight of the charge transporting layer.

11. The electrophotographic photoreceptor of claim 9, wherein the charge generating layer comprises an organic pigment and a binder resin.

12. A method of improving dark decay characteristics of an electrophotographic photoreceptor, the method comprising:
adding an effective amount of a titanium chelating compound to a charge transportation layer formed on the electrophotographic photoreceptor, wherein the titanium chelating compound is represented by Formula 1 below: 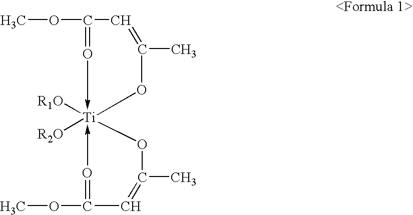
and, wherein R₁ and R₂ are each independently a C₁—C₂₀ linear or branched alkyl group.

13. The method of claim 12, wherein the effective amount of the titanium chelating compound is less than 0.20% by weight based on a total weight of the charge transporting layer.

14. The method of claim 12, wherein an effective amount of titanium chelating compound improves the dark decay characteristics of the electrophotographic photoreceptor while not substantially reducing a sensitivity of the electrophotographic photoreceptor.
